(19) United States
(12) Patent Application Publication
(10) Pub. No.: US 2006/0031820 A1
(43) Pub. Date: Feb. 9, 2006

(54) Method for program transformation and apparatus for COBOL to Java program transformation

(76) Inventor: Aizhong Li, Ottawa (CA)

Correspondence Address: Aizhong Li, 18 Sunvale Way, Ottawa, ON, K2G 6Y2, CA

(21) Appl. No.: 10/913,973

(22) Filed: Aug. 9, 2004

(51) Int. Cl. G06F 9/45

(52) U.S. Cl. 717/137

(57) ABSTRACT

The present invention relates to a method for program transformation and an apparatus for COBOL to Java program transformation. The method consists of: (1) a new approach for statement-to-statement program transformation, facilitated by a predefined target language library, which keeps original comments, program control flow, functionality, and time complexity; (2) a new approach for goto statement elimination, which uses existing exception handling mechanism in target language and its implementation is hidden in a super class in a library; (3) a new extended BNF to distinguish different occurrences of the same term in a BNF production; (4) a new approach for embedded statement as a special marker statement and a comment, (5) in the description of the above, a program transformation specification language is defined to describe relationship between comments in two languages. (6) an apparatus, as the preferred embodiment of the method, is a COBOL to Java program transformation system Cobol2Java; a sample COBOL application and its Cobol2Java translation are given.

### BACKGROUND OF THE INVENTION

1. Field of the Invention

The present invention relates to computer language and computer programs. Specifically the present invention relates to methods and apparatus for program transformation from one computer language into another computer language. More specifically, the invention relates to program transformation from COBOL language to Java language at source code level.

2. Background Art

The behavior of a computer is controlled by program at source code level directly or indirectly. Therefore present invention will focus on source code rather than executable binary code. Business application code controls business application system. Over time, companies have accumulated a large amount of programs as source code. Unfortunately, computer systems and programming technologies have advanced so fast that much of the existing code, which was written in traditional languages with obsolete features (such as goto statement in COBOL) for old platforms (such as mainframes), is now unable to take the advantages of modern computer systems (such as personal computer running Windows) and programming technologies (such as virtual machine and object oriented method).

Object-oriented programming technology is the most advanced and mature technology for programming. Object-oriented programming makes software system analysis, design, implementation and maintenance much more productive. Other advanced and mature technologies in computer industry, such as database, GUI, and computer network, are widely used. Inside network computing environment, programs may be stored on one computer and run on another computer, as required. Java language, defined by Sun Microsystems, Inc., and C# defined by Microsoft Corp. are virtual machine based object-oriented languages, which are platform-independent and represent the latest advancement in programming technology. The present invention focuses on transformation to Java program without excluding C# and other modern languages, such as Ada, C++.

According Gartner Group, Research Note, February 2001, over 70% mission-critical business applications are still written in COBOL (Common Business Oriented Language) as defined in ANSI X3.23-1985/ISO 1979-1985 with two amendments ANSI X3.23a-1989 and ANSI X3.23b-1989. Therefore the present invention will focus on COBOL to Java program transformation without losing generality to other traditional languages, such as FORTRAN and assembly languages.

Traditional languages are not object-oriented. Goto statement is used in legacy applications. But Goto statement violates structured programming methodology as described in the paper “Go To Statement Considered Harmful” by Edsger W. Dijkstra Goto statement may lead to high maintenance cost. According to Gartner Group, Research Note, 1997, over 180 billion lines of COBOL code are in use, with an estimated 5 million new lines added per year. The scale of COBOL code makes manual transformation impossible in time and budget and therefore it requires an automatic program transformation tool. The regularity of program in terms syntax structure makes such an automatic transformation possible.

There are several approaches to automatic program transformation in general:
1. Access legacy applications through a bridge or a middleware. This approach requires the maintenance of both original applications and the bridge. In the long run, the maintenance cost will increase rather than decrease. For example, Micro Focus product Express allows Java to access COBOL through their runtime support.
2. Recompile Cobol source code into a new executable format. This approach doesn't decrease the maintenance cost of original code. For example, PERCobol from LegacyJ Inc. complies COBOL into Java binary class.
3. Transform legacy code into object-oriented source code.

The present invention focuses on the maintainability of generated Java code, because all programs were originally designed by programmer and are maintained by programmer manually. According to Compaq, “TCO Models and Approaches,” www.compaq.com/tco, “up to 80% of IT cost are incurred after initial deployment” i.e. maintenance.

There are several technical challenges for COBOL to Java program transformation at source code level:
1. Maintainability. Inside business applications, business rules of the business logic are hard-coded in statement sequences. Inline comments explain the usages of programming artifacts in terms of their business roles. Therefore for better maintainability of program, the target code should have the same structure as the original. If the target program is quite different from the original, it is not easy for a programmer to maintain it using existing experience and documents. Statement-to-statement transformation, as defined in present invention, is easy to understand, but it is difficult to achieve because the difference between the two languages. Brian J. Sullivan from LegacyJ Corp. described a pattern-based approach for COBOL to Java transformation in U.S. Pat. No. 6,453,464. In his approach, the maintainability of target program is shifted to patterns and he doesn't address goto statement elimination problem. He recommended PERCobol as solution. “It's not COBOL to Java conversion, but rather compiling COBOL to work in the Java environment with extremely simple integration between the two. We believe there's a number of accuracy, performance, and maintenance tradeoffs in translation, so we encourage people to keep the code in COBOL source for maintenance so we can have accuracy and continue to upgrade our compiler/runtime's performance over time.” (Brian Sullivan, LegacyJ Corp. posted in newsgroup comp.lang.cobol, dated Sep. 9, 2003 21:51:55, titled as: “Re: COBOL to Java Conversion” in: http://www.talkaboutprogramming.com/group/comp.lang.cobol/messages/124253.html). In present invention, a statement-to-statement approach is described to solve maintainability problem.
2. Elimination of goto statement, native API and obsolete API (such as COBOL file API) for a portable program. Goto statement elimination is unavoidable in COBOL to Java transformation because Java doesn't contain goto statement at all. There are several approaches to elimination of goto statement. The common problem is the tradeoff between maintainability and efficiency. Sylvain Reynaud eliminates goto statement by changing program structure in U.S. patent application 20030233640. His approach loses maintainability because frequent changes of structure make the business logic difficult to understand. Some approaches eliminate goto statement by adding artificial structures into translated code. Peter Carl Bahrs etc. eliminate goto statement by transforming every statement into an object and build an extra stack for flow control of goto statements in U.S. Pat. No. 6,002,874. Their approach suffers in both maintainability and efficiency because too many objects need to be created and maintained. CG WU described a similar approach by transformting every paragraph into an object. Some approaches add extra variables, such as in method of S. Pan and R.G. Dromey. Some approaches are based on code or method replication, for example transformation system CORECT by Softwaremining Inc. copies all method calls from goto statement label to the end of program. This approach can create extremely long code if there are many goto statements with first label as go to target labels. In present invention, goto statement is eliminated by use of exception handling mechanism without creating extra stack or variable.
3. Efficiency versus flexibility in terms of running time of generated program and the time needed to build such a transformation system to deal different dialects of a traditional language. Current goto statement elimination methods generate longer code or needs more object creation at runtime and thus lead efficiency problem. Brian J. Sullivan uses metalanguage tool YACC tool to generate his parser in U.S. Pat. No. 6,453,464 to save transformation system construction time. There are JavaCC like YACC and BNF API in Java in project: BNF for Java from http://bnf-for-java.sourceforge.net. But they can't distinguish two occurrences of the same term and can't make across reference of terms in two languages. In present invention, BNF API is designed as generic parser rather than parser generator and skeleton translator code is generated automatically.
4. Handling embedded statement such as SQL statements is normally treated as extension of source language, such as in U.S. Pat. No. 6,453,464. This approach leads to a complex transformation system. In present invention, embedded statement is preprocessed as comment and marker statement to simplify transformation system.
5. Making best use object-oriented methodology in generated code, such as code sharing by inheritance, polymorphism for generic types and encapsulation of primitive type toward true object-oriented are less addressed in program transformation. In present invention, a target language library is used as the basis for object oriented inheritance, polymorphism and encapsulation in target language code.
6. The lack of method to describe program transformation. Brian J. Sullivan from described a pattern-based approach for COBOL to Java transformation in U.S. Pat. No. 6,453,464. But it lacks the cross reference between two languages. In present invention, BNF is further extended to distinguish terms inside a production in a language and terms in two languages.

In order to tackle the above problems, a new method for program transformation is needed.

### BRIEF SUMMARY

The present invention relates to a method for program transformation and an apparatus for COBOL to Java program transformation. The method consists of: (1) an approach for statement-to-statement program transformation, facilitated by a predefined target language library representing original terms, which keeps original business logic or program control flow, functionality, and time complexity; (2) an approach for goto statement elimination, which uses existing exception handling mechanism; (3) the use of further extended BNF in generic parser and generic skeleton transformation system generation; (4) an approach for embedded statement processing, which preprocesses embedded statement into a special marker statement with special comment. (5) In the description of the above, a program transformation specification language is defined and used. The apparatus, as the preferred embodiment of the method, is a COBOL to Java program transformation system, which automatically transforms a COBOL 74/85 program with embedded statements into a Java program at source code level.

The program transformation specification language accurately specifies the program transformation process; it can further facilitate an automatic program transformation based on such a specification. The Statement-to-statement program transformation approach generates program with the same business logic and the original comments, and thus preserves maintainability. The target language library not only makes statement-to-statement translation possible but also generates true object oriented code by use of inheritance, polymorphism and encapsulation, it increase maintainability. The goto statement elimination approach uses exception-handling mechanism and existing stack in target language, thus it keeps performance and maintainability. The use of metalanguage for generic parser and transformation system generator save transformation system construction time and efforts when dealing with different dialects of a source language. The embedded statement processing approach makes transformation system less complex. In the preferred embodiment of the method, a COBOL to Java program transformation system translates COBOL source code with embedded SQL statements into object oriented Java source code with JDBC calls.

### DRAWINGS

FIG. 1 is a block diagram illustrating a COBOL to Java program transformation system, which is used to implement the present invention.

FIG. 2 is a sample COBOL application containing GO TO statement and PERFORM statement.

FIG. 3 is the Java translation output by Cobol2Java of above sample COBOL application.

### DETAILED DESCRIPTION OF THE INVENTION

In the following description, the meanings of some words, such as “method”, “procedure” and “function”, are context sensitive depending on the computer language used.

1. Extended BNF

John Backus and Peter Naur introduced BNF (Backus Naur Form) in ALGOL 60 language specification. It is now used in definition of almost all computer languages. Extended BNF is specified in ISO/IEC 14977: 1996(E). The following extensions to the extended BNF are for the following reasons:
To distinguish different occurrences or instances of the same term in a production;
To express relationship between terms of two languages;
To specify lexical and grammatical structure in the same form;
To specify global characteristics of a language.

First, the extended BNF, used as a metalanguage to define a single language, is defined. Then in next section, it is extended further to express relationship between two languages. The extended BNF grammar is a piece of text in the following format:
{CommentLine}{Header}{Production>|CommentLine}

Where CommentLine is a line of comment which starts and ends with the character @ Header consists of one or more of the flowing lines to specify global features of a language:
Start Term: NonterminalTerm to specify the topmost grammatical term.
Is Comment Allowed: true{false to specify if comment is allowed in Start Term.
Tokens: {Term} to specify grammar terms which comment is not allowed.
Is Case Free: true|false to specify whether target language is case sensitive.
Free Spaces: <characters> to specify space characters in target language excluding the brackets.

Production is of the following form: NonterminalTerm::=Term. Where Term includes:
UniTerm, with one operand, including:
   EnclosedTerm, of form, (Term)
   OptionalTerm, of form, [Term]
   RepeatedTerm, of form, {Term}
BiTerm, with two operands, including:
   ChoiceTerm, of form, DCNTerm|DCNTerm, where DCNTerm is one of: DifferenceTerm, ConcatenationTerm, UniTerm and PrimitiveTerm.
   DifferenceTerm, of form, CTerm−CTerm, where CTerm is one of ConcatenationTerm, UniTerm and PrimitiveTerm.
   ConcatenationTerm, of form, NonBiTerm NonBiTerm, where NonBiTerm is either PrimitiveTerm or UniTerm.
PrimitiveTerm, without inner terms, including:
   NonterminalTerm, of the form <CategoryName[@InstanceName]>, where CategoryName is a category name for target language elements, and the optional InstanceName is used to distinguish terms of same category name to access a specific instance.
   TerminalTerm, it may be one of:
      DelimitedTerm, of form, #char1:char2#, defines a string. delimited by char1 and char2.
      RangeTerm, of form, ′char1:char2′, defines a char in the range from char1 to char2.
      StringTerm, of form, “String”, defines a string as it appears excluding quotations.

See next section for examples of BNF used in language definition.

2. Generic Parser and Instance Tree

BNF defines the generic structure of programs in a language. For a program, it is parsed as an instance of BNF grammar. When the BNF terms themselves are implemented as classes, it serves as a generic parser with parsing and unparsing methods. The parsing result as a generic instance tree is defined as follows:
The root is the instance of start term and it has no parent.
The nodes of the tree are instances of terms. The same term may occur in the tree to represent different instance. All nodes, except root, have a parent. All nodes, except leaf nodes, may have some children.
The leaf nodes are terminal terms or nonterminal terms marked as token. Leaf nodes have no child.
For UniTerm,
   EnclosedTerm, of form, (Term), it has one child defined by Term and the parent of Term is the EnclosedTerm.
   OptionalTerm, of form, [Term], it has at most one child defined by Term and the parent of Term is the OptionalTerm.
   RepeatedTerm, of form, {Term}, it has arbitrary number of children defined by Term and the parent of all Term is the RepeatedTerm.
For BiTerm, with two operands, including:
   ChoiceTerm, of form, DCNTerm|DCNTerm, it has one child defined by a DCNTerm and the parent of DCNTerm is the ChoiceTerm.
   DifferenceTerm, of form, CTerm−CTerm, it has one child defined by the first CTerm and the parent of CTerm is the DifferenceTerm.
   ConcatenationTerm, without explicit operator, of form, NonBiTerm NonBiTerm, it has same number of children defined by NonBiTerm and in the same order. The parent of NonBiTerm is the ConcatenationTerm.
For PrimitiveTerm, without inner terms, including:
   NonterminalTerm, of form: NonterminalTerm::=Term. if it is not a token, it is a node with children defined by Term and the parent of Term is the NonterminalTerm. If it is a token, it is a leaf node holding an instance value as a string defined by Term.
TerminalTerm, it defines a leaf node holding an instance value and its parent defined as above when used as an operand.

3. The BNF API

The BNF API serves the following functionality depending on the time of use:
BNF reader API, which read BNF text into memory. It is implemented as constructors in a term.
Generic parser API that uses BNF to parse a program segment. It is implemented as method parse( ) and method unparse( ) in a term.
Skeleton generator API, which generates a transformation system skeleton and it is implemented as a utility class called Classfier.
Instance access API, which is used to access grammatical term instance. It is implemented as instance access method in Terms.

The Instance access API includes the following method depending on a Term:
String getInstance( ) return the instance value of the term.
String getValue( ) return the instance value of the term without comments.
Term[ ] getInstance(String name) returns the children as an array by name. If the term has no child, an array of length zero is returned.
String getInstanceName( ),
   For nonterminal term, of the form <CategoryName>, returns CategoryName as it appears; of the form <CategoryName[@InstanceName]> returns InstanceName as it appears;
   For terminal term, it is undefined and throws exception.

The parent of a term is not a stored for efficiency of BNF API, but it is stored as a member field in translation procedures generated for the term, because no all translation system needs bi-directional search. A getParent( ) method can be implemented instead of a field.

With BNF API, an instance tree can be traversed and across reference to sub-instance is available for program transformation, independent of transformation method used.

4. Program Transformation Specification Language

Both YACC and JavaCC is generic parser generator. They express translation rules in terms of source language BNF structures along with embedded C or Java code. Target language structure is hidden. The following approach uses BNF definitions of both languages. The present approach is bidirectional rather than unidirectional as most YACC or JavaCC rules may be. In all, the present approach is to make program transformation specification easier to understand, rather than to add more ability of expressiveness to a parser. It focuses on the relationship between two languages in terms of grammatical terms. Program transformation specification rules defined in present approach are equivalent to two sets of rules in YACC or JavaCC. Replacement of the present transformation specification format with equivalence in YACC or JavaCC format doesn't affect any other part of present invention.

For the description of program transformation between a source language and a target language, a formal specification language is designed below as a metalanguage to express a transformation process:
Both the source language and the target language are expressed in BNF form following a special naming convention and transformation function specification.
The source language NonterminalTerm is enclosed by “<” and “>” and target language NonterminalTerm is enclosed by “<<” and “>>” to distinguish terms in different languages.
UserDefined is a special NonterminalTerm name prefix for user specified information that is not available from source language. For example <<UserDefinedTermName>> represents an instance of <<TermName>> in the target language, but its instance value isn't obtained from source language instance. “Space”, such as comments, carriage return and/or new line, may be inserted into target language for code clarity without changing the functionality.

For clarity of the present description, Some “Spaces” are added without affecting the semantics of a program.
A NonterminalTerm <<TermName>> is the translation of <TermName>, where TermName is the name of a syntax category in both languages.
Bold word specifies the invocation of an embedded transformation function or condition name.
The invocation of a transformation function or condition is represented as methodName(<NonterminalTerm>, . . . , <NonterminalTerm>)
where comma and parentheses are used as argument separators rather than target language elements. Transformation function or condition may occur only in the right hand of a production rule. If it is a condition and returns false, the following term is excluded. The return value of a function is insert into the language.

Method may be qualified (such as per Java convention) for clarity. The bodies of above transformation function or condition are defined as method or function in a computer language or a natural language. In the preferred implementation, it is written in Java. BNFAPI can be used in the implementation, along with implementation language statements. Below is a template:

[ booolean | String] methodName({Term t})
{
// method implementation details
}
where Term t is the instance of corresponding <Term> of the same
instance name as it appears. In implementation, the method can be
organized, such as a Java class inside a package.

The change of marker symbols and transformation function or condition definition convention doesn't affect the above language. Transformation function or condition definition in a computer language is preferred and a fully automated transformation system can be build based on a program transformation specification from a source language to a target language with a set of transformation function for the two languages. The present invention uses the transformation specification language to define COBOL to Java program transformation method, but the present invention doesn't exclude the use of above specification language to other languages. In practice, it is better to use development language for the transformation function/condition definitions. The source language, the target language, the transformation function/condition definition language and the transformation specification language can be any computer language or even a natural language as long as it can be defined in BNF form.

The above program transformation specification language is used in the following state-to-statement program transformation approach description and goto statement elimination approach.

5. State-To-Statement Approach Program Transformation

The statement-to-statement approach is presented using COBOL and Java as source and target language; other language can be used in a similar way. Because full COBOL language syntax in BNF format is lengthy, only typical elements are described in the present description. Here “typical” means, with background knowledge, one can apply the method to similar BNF structure in the language. A complete COBOL syntax in extended BNF format is included as cobol.def in def folder of Computer Program Listing. A complete set of COBOL language translation procedures is included in cobol2java and cobol/lib folders of Computer Program Listing. Please note that terminal terms are not quoted in present description for clarity.

```
Let a COBOL program be defined as:
  <Program>::= < ProgramName > <DataDivision><ProcedureDivision>
It is translated into Java program:
<< Program>> ::= [<<PackageDeclaration>>]
    <<ImportDeclaration>>
    public class <<ProgramName>> [extends CoProgram]
    {
    << DataDivision>>
    << ProcedureDivision>>
    }
where
  <<PackageDeclaration>> ::= package << UserDefinedPackageName>>;
  <<ImportDeclaration>> ::= import cobol.lang.*;  // Java library for
      COBOL isContainsSql(<Program>) import java.sql.*;
  <<ProgramName>>::= Name.toClassName(<ProgramName>)
where toClassName ( ) translates a COBOL name into a Java class name
and toVariableName ( ) translates a COBOL name into a Java variable
name per Java naming convention, isContainsSql ( ) tests whether a
portion of program contains a SQL statement.
```

Now, turn to COBOL data division. For clarity, only working section is described below.

Let a COBOL data division be defined as:

<DataDivision>::= {<FieldSpe>}

It is translated into Java as:

<<DataDivision>>::= {<<FieldSpec>>}

Let a COBOL field specification be defined as:

| | |
|---|---|
| <FieldSpec>::= | <ElementaryFieldSpec> \| |
| | <GroupSpec> \| |
| | <RedefineFieldSpec> \| |
| | <ConditionFieldSpec> \| |
| | <ArraySpec> |

It is translated into Java as:

| | |
|---|---|
| <<FieldSpec>>::= | <<ElementaryFieldSpec>> \| |
| | <<GroupSpec>> \| |
| | <<RedefineFieldSpec>> \| |
| | <<ConditionFieldSpec>> \| |
| | <<ArraySpec>> |

```
Let a COBOL elementary field specification be defined as:
      <ElementaryFieldSpec>::=  <DataName><Type>[<InitialValue>]
It is translated into Java as:
  <<ElementaryFieldSpec>>::=public<<Type>><<dataName>>
[=<<InitialValue>>]; where <<Type>> is one of several predefined Java
type, <<dataName>> is toVariableName(<groupName>), and
<<InitialValue>> is the invocation of constructor of the type. All the
predefined types are specified in Java library for COBOL in cobol/lang
folder of Computer Program Listing.
Let a COBOL group field specification be defined as:
          <GroupSpec>::=  <groupName>{<FieldSpec>}
It is translated into an inner Java class as:
```

| | |
|---|---|
| <<GroupSpec>>::= | class toClassName(<groupName>) extends Group |
| | { |
| | {<<FieldSpec>>} |
| | } |
| | // create an instance |
| | public toClassName(<groupNam>>) |
| | toVariableName(<groupName>) = new |
| | toClassName(<groupName>)( ); |

Where group is a predefined class cobol/lang folder of Computer Program
Listing.

The same mechanism can be used to redefine and rename fields. If redefine field is inside a group, an offset and length need to be specified in the constructor. The offset and length can be calculated by use of picture strings in COBOL. Conditional field is translated into a Java method of condition name, which has no argument, return a Boolean and its body is the translation of condition on the field. Sections in data division are treated the same as a group with section name.

```
Now let's turn to procedure division. Let procedure division be defined as:
          <ProcedureDivision> ::= {<paragraph}}
It is translated into Java as:
      <<ProcedureDivision>> ::= {<<paragraph>>} <<EntryPoint>>
The <<EntryPoint>> will be defined in next section because it relates goto
statement and perform statement handling.
Let a paragraph be defined as:
        <paragraph> ::= <paragraphName> {<statements>}}
It is translated into Java as:
  <<paragraph>> ::= public void toVariableName(<paragraphName>)
  {
    {<<statements>>}
  }
```

Normal operational statements except flow control statement are translated into Java statements on corresponding object with similar statement names. Some statements, which need more lines of code, are translated calls of static shortcut methods in class cobol.lang.Cobol as in Computer Program Listing to ensure statement-to-statement translation on a statement-by-statement basis. But some flow control statement, e.g. goto statement, needs to be treated differently.

6. Goto Statement Elimination and PERFORM Statement Translation Approach

COBOL program has no explicit entry point, but Java requires an explicit one.

```
Let a COBOL program be:
        <Program>::= <ProgramName> {<ParagraphName>}
Because COBOL program has no named entry point, a named entry point is added as
follows for standalone application:
/** entry point for standalone application */
  public static void main(String[ ] args)
  {
    toClassName (<<ProgramName>>) toVariableName(<<ProgramName>>)
    = new <<ProgramName>> ( );
    // Note: if COBOL paragraph name or order changes, this array should changes
    String[ ] paras = { {“<<ParagraphName>>” }};
    toVariableName(<<ProgramName>>).paragraphs = paras;
    toVariableName(<<ProgramName>>).entry( ); // call entry point
  }
where entry( ) is a method defined in cobol.lang.CoProgram in Computer Program Listing.
In side entry( ) method, exceptions are caught and processed depending their instances.
The same procedure can be applied to subprograms with additional parameter passing
and instance creation as a class member for object sharing between subroutine calls.
Please note that the above main( ) method stores all paragraph names. For more efficiency,
only called paragraph labels are needed to store. A called paragraph is paragraphs, which
label occurs in other statement such as goto statement and perform statement.
```

Now, let's turn to goto statement elimination. Let a goto statement be:

<GotoStatement>::= goto <Label>

It is translated into Java as:

<<GotoStatement>>::= throw new GotoException(<<Label>>);

Let a goback statement be:

<GobackStatement>::= goback

It is translated into Java as:

<<GotoStatement>>::= throw new EndOfProgramException( );

where GotoException and EnfOfProgram are defined in cobol.lang in Computer Program Listing, where GotoException needs to remember a level. In Java implementation, they are unchecked exception extending java.lang.RuntimeException.

At the same time a COBOL perform statement is translated into a method call as follows:
PERFORM para1 through para2 is translated into a java method call perform(“para1”, “para2”); where “para1” and “para2” are translated form of corresponding COBOL paragraph names correspondingly.

By inheriting method perform( ) and entry( ) method from cobol.lang.CoPorgram, the target Java program length doesn't increases except in the added entry point main( ) method. This approach brings the following benefits:
Translated methods are free of order,
Localized and hid goto statement related handling in a super class,
Enhanced statement-to-statement translation,
Without losing runtime performance in terms of time complexity order,
Without changing business logic or program control flow,
No extra call stack is added and the existing target language call stack is used.

Now let's turn to Exception handling and perform implementation inside cobol.lang.CoProgra. perform( ) is a loop from start label to end label by invoking corresponding Java method by reflection. In each invocation GotoException and EndOfProgramException need to be passed through. perform( ) is a loop from first label to last label by invoking corresponding Java method by reflection. In each invocation GotoException and EndOfProgramException need to be processed. For GotoException, the loop is reset and continued. For EndOfProgramException, the loop is terminated. For more efficiency, runtime method objects can be pulled out once statically and stored as a hash table for fast invocation.

7. Skeleton Transformation System Generator

By use of BNF API, a COBOL translator skeleton can be generated automatically. If the right hand of a production consists of only one level of operations, the generated result will be easy to read. For every production of the form NonterminalTerm::=Term. a corresponding Java class is generated as follows:
Extends a base class Node for generic tree structure,
Member fields from Term for each of its constituents, as defined below:
UniTerm, with one operand, including:
   EnclosedTerm, of form (Term), a variable Term term is defined and initialized, where term is the first letter lowercase form of Term in name as appeared.
   OptionalTerm, of form, [Term], a variable Term term is defined and initialized, possible to null.
   RepeatedTerm, of form, {Term}), a variable Term[ ] terms is defined and initialized, possible to Term[0].
BiTerm, with two operands, including:
   ChoiceTerm, of form, DCNTerm|DCNTerm {|DCNTerm} a variable Node choice is defined and initialized to the selected instance.
   DifferenceTerm, of form, CTerm−CTerm {−CTerm} a variable CTerm CTerm is defined and initialized to the first instance.
   ConcatenationTerm, without explicit operator, of form, NonBiTerm NonBiTerm {NonBiTerm} a variable NonBiTerm[ ] nonBiTerms is defined and initialized corresponding to each term in the same order.
PrimitiveTerm, without inner terms, including:
   NonterminalTerm, of the form <CategoryName[@InstanceName]> A variable of type CategoryName named as categoryName is defined if InstanceName is absent or instanceName is defined and initialized to its instance. For NonterminalTerm as token, a String variable is defined to store the instance value.
   TerminalTerm, no variable is defined.
Constructor has two arguments a parent Node and an instance nonterminal
A method, for example, public StringBuffer tojava(int indent) where the StringBuffer is the returned translation result and indent for code indentation. The body of the methods is left for further implementation.

8. Embedded Statement Processing Approach Embedded statement, like embedded SQL statement, has special start and end markers, like EXEC SQL <SqlStatement> END-EXEC. Normally embedded statement is send to another system for execution as a pass-through. The only processing in host language is host variable access. And the host variable is marked with another special prefix, like the column in :hostVariable. Without detail parsing, it is processed as follows:
By use of precompiler, preprocess EXEC SQL SqlStatement END-EXEC into the following comment and a marker statement:
   /* EXEC SQL SqlSlatement END-EXEC */ embedded
where original embedded statement is translated into a quoted comment and a special marker statement embedded is added and it is defined as a normal COBOL statement.
Because program transformation system keeps comments, when processing statement embedded, the comment content is retrieved back and original embedded statement is processed.

This approach makes source language BNF definition to the shorter and thus makes transformation system less complex, save transformation system building time and efforts.

9. COBOL to Java Program Translation System

A COBOL to Java source code program transformation system, Cobol2Java, is described as the preferred embodiment of the program transformation method in present invention.

9.1 Implementation of the Java Library for COBOL

The class hierarchy of Java library for COBOL is as follows: class cobol.lang.Base (implements java.lang.Cloneable, java.io.Serializable)
class cobol.lang.Group implements group behavior
class cobol.lang.PrimitiveTvpe implements behavior of elementary types
   class cobol.lang.Alphabetic corresponds to COBOL type
   class cobol.lang.Alphanumeric corresponds to COBOL type
   class cobol.lang.AlphanumericEdited corresponds to COBOL type
   class cobol.lang.Numeric implements common behavior of Numeric type
      class cobol.lang.CoByte implements Java byte with picture
      class cobol.lang.CoDouble implements Java double with picture
      class cobol.lang.CoFloat implements Java float with picture
      class cobol.lang.CoInt implements Java int with picture
      class cobol.lang.CoLong implements Java long with picture
      class cobol.lang.CoShort implements Java short with picture
      class cobol.lang.NumericEdited corresponds to COBOL type

class cobol.lang.Cobol implements COBOL statements requiring multiple lines in Java

class cobol.lang.CoFile implements common behavior of COBOL files
class cobol.lang.indexedFile corresponds to COBOL type
class cobol.lang.PrinterFile corresponds to COBOL type
class cobol.lang.RelativeFile corresponds to COBOL type
class cobol.lang.SequentialFile corresponds to COBOL type

class cobol.lang.Collating corresponds to COBOL collating

class cobol.lang.Condition represents comparator as an object for convenience.

class cobol.lang.CoProgram implements perform( ) and entry( ) for goto and perform.

class cobol.lang.FormatInfo represents format info for convenience.

class cobol.lang.Intrinsic implements intrinsic functions as static methods.

class cobol.lang.KevFile index file for IndexedFile implementation.

class cobol.lang.Parameter implements smart setters forjava.sql.PreparedStatement

class cobol.lang.PicString corresponds to COBOL picture string

class java.lang.Exception
class cobol.lang.EofException corresponds to COBOL end of file
class cobol.lang.invalidKevException corresponds to COBOL invalid key
class java.lang.RuntimeException
   class cobol.lang.EndOfProgramException
   class cobol.lang.GotoException

Detail method level definition can be found in cobol.lang package of Computer Program Listing.

9.2 COBOL to Java Program Transformation System

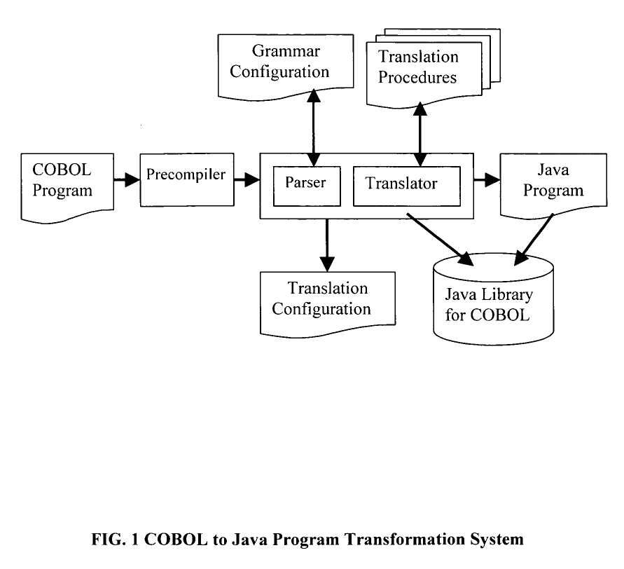

As depicted in FIG. 1, the COBOL to Java program translation system consists of the following components:
1. The input COBOL program as defined in COBOL 74/85 standards with embedded SQL and CICS extension.
2. The precompiler, which translates the input COBOL program into an intermediate form while performing the following functions:
   Eliminate sequence number and text out of right margin,
   Eliminate COBOL debug lines,
   Merge continuous lines into a single line,
   Transform COBOL comment line into quoted form comment like /* comment */,
   Expand COPY and SQL INCLUDE statements,
   Process an embedded SQL statement into a comment and an embedded statement marker,
   It is implemented as cobol2java.Preprocessorjava in Computer Program Listing.
3. The output Java program as defined by Sun Microsystems in text form. In this implementation, one COBOL program generates one Java program. But it may be one to many if inner classes are put into single files.
4. The parser, which parses the intermediate COBOL source code into bidirectional tree in memory based on COBOL grammar configuration in BNF format file. It is implemented as bnf package in Computer Program Listing.
5. COBOL grammar configuration in BNF format, which defines a COBOL dialect. It is defined in file def/cobol.def in Computer Program Listing.
6. Translation Procedures, which are a set of translation processes that each of them corresponds to a specific grammatical term defined in grammar configuration. In this implementation, the Translation Procedures are implemented in Java. All the procedures are implemented in cobol.lib package in Computer Program Listing.
7. The translator, which is a Java application that uses parsing result, configurations, and call a translation procedure specified in BNF configuration as the start term to perform translation. It is implemented in cobol2java package in Computer Program Listing.
8. Translation configuration, which provide some information not available in COBOL source code, for example JDBC connection parameters and translation method selection for a grammatical term with multiple translation options. It is implemented as def\cobol2java.cfg file with Cobol2JavaSettingsjava to read\write it.
9. Java Library for COBOL, which is a Java implementation of COBOL data types, file types and some complex COBOL statements to bridge the gap between COBOL and Java and make output Java code easy to read in statement-to-statement translation.

There is no special requirement for a computer and a development language in the present invention. The preferred embodiment, a COBOL to Java program translation system, uses a 2.4 GHz Pentium 4 with 512M memories with 80 G hard disk and uses Java as development language. In above implementation, translator related implementation is compiled and packed into a JAR file. Java Library for COBOL is packed into another JAR file, which may include source code for detailed debugging.

9.3 COBOL to Java Translation Operations

The operation of program translation is the same as normal two-phase compiler. For example, using Sun Microsystems's Java compiler and runtime:
1. Invoke the translator as follows:
   java-classpath cobol2java.jar cobol2java.Cobol2Java cobolFile
where cobol2java.jar is the jar file containing COBOL to Java programtransformation application, cobol2java.Cobol2Java is the main class, and cobolFile is a COBOL source file. It will generate a Java program with file name translated from program name.
2. Invoke Java compiler as follows:
   javac-classpath jclib.jar translatedJavaFile
where jclib.jar is the jar file containing Java library for COBOL.
3 If it is an Java application, run translated Java program as follows:
   java-classpath jclib.jar compiledJavaClass
4. At any time, you can debug the translated Java code at two levels using a debugging tools and specifying the following:
   At application level, by specifying Java Library for COBOL binary classes
   At detailed level, by specifying Java Library for COBOL source code
5. At any time, user can change grammar specification by adding, deleting and changing grammatical terms. At any time, user can change program transformation procedures by adding, deleting and changing translation procedures. At any time, use may change Java Library for COBOL implementation by giving new implementation without changing the method signature.

In the preferred embodiment, a Java runtime is required to run the COBOL to Java program transformation system. Java runtime is free from Sun Microsystems Inc. web site http://java.sun.com/j2se/. On a run of Cobol2Java on a Pentium 4, it translated 16,000 lines of code in 4 minutes. Therefore Cobol2Java can translate more than 5 million lines of COBOL code in a single day without supervision or error.

9.4 COBOL to Java Translation Samples

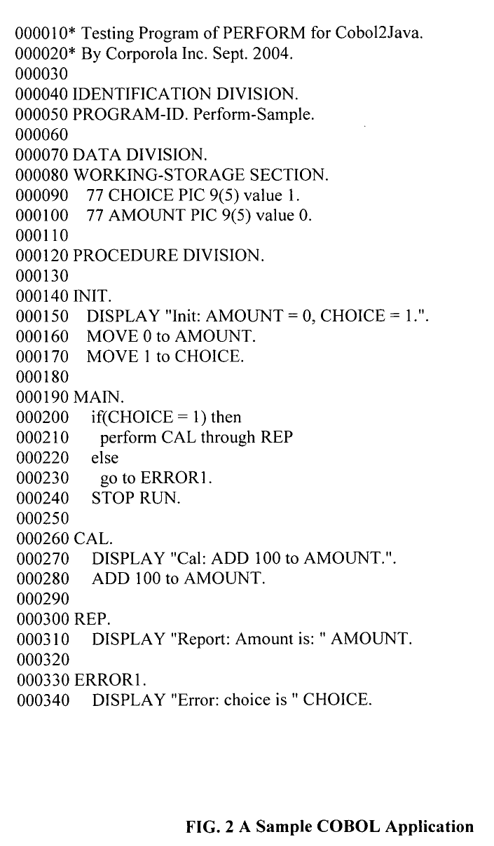

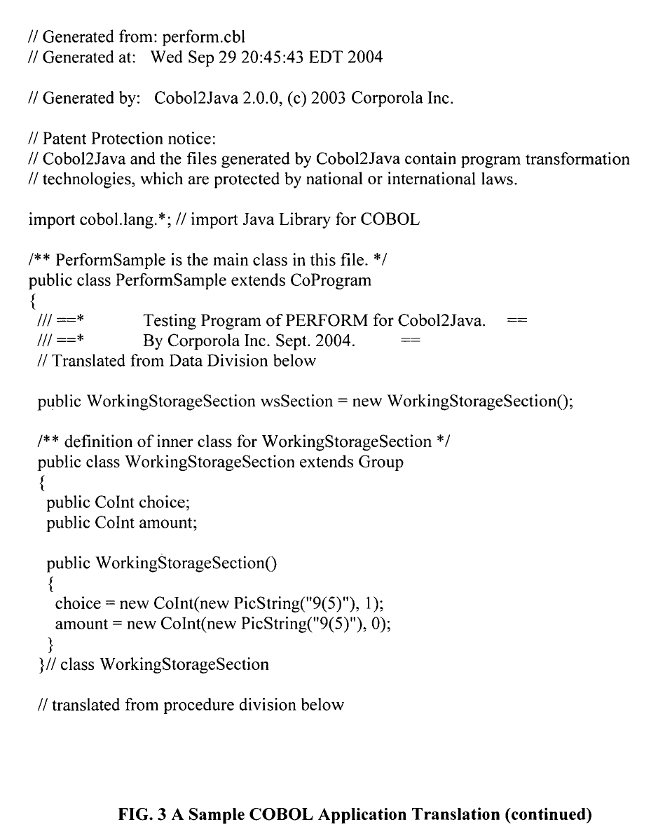

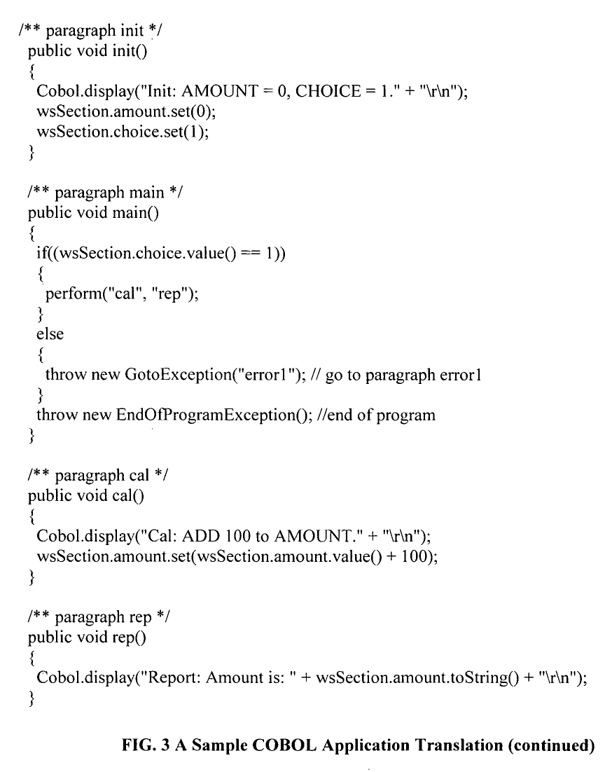

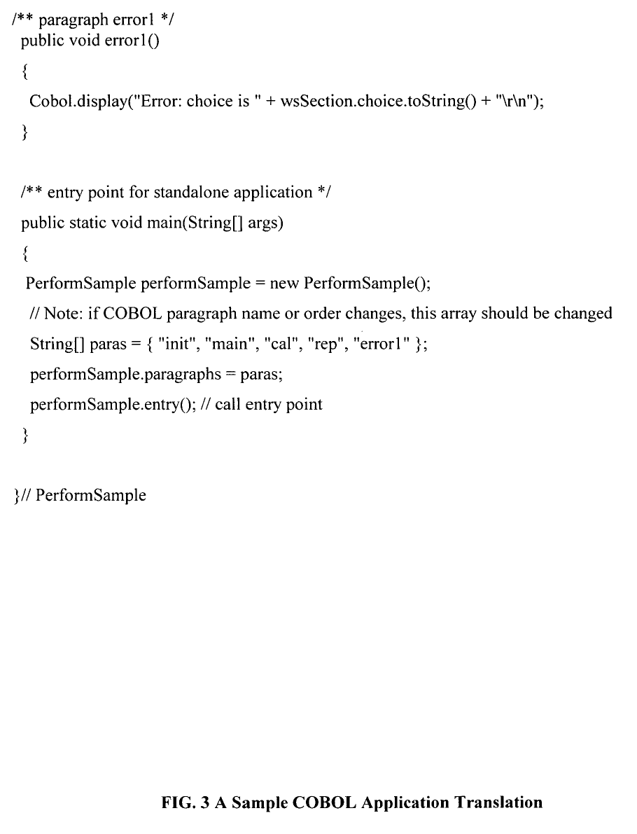

A sample COBOL application is given in FIG. 2 and its Java translation by Cobol2Java program transformation system is given in FIG. 3. The statement-to-statement correspondence between the original COBOL program and translated Java program can be found easily by using a Java editor with syntax color set properly. A detail explanation is available from Corporola Inc. website: www.corporola.com

I claim:

1. A method for program transformation, comprising of:
An extended BNF formalism to define languages and relationship between components in one and between two languages,
Generic parser and bi-directional instance tree based on BNF,
BNF API to access language components,
A program transformation specification language using extended BNF,
Skeleton program transformation system generator using BNF,
The statement-to-statement program transformation approach by use of a target language library,
The goto statement elimination approach by use of exception handling mechanism, along with perform and goback statement implementation for flow control,
The embedded statement processing approach by use of a comment and a marker statement,
A COBOL to Java program transformation system using the above approaches.

2. An apparatus, i.e. a COBOL to Java program transformation system implemented as a Java program running on a computer based on the method if claim 1.

3. The extended BNF formalism of claim 1, wherein it further consists of:
{CommentLine}Header {Production|CommentLine}
Where CommentLine is a line of comment which starts and ends with the character @
Header includes, but not limited to, the flowing lines to specify global features of a language:
Start Term: to specify the topmost grammar term.
Is Comment Allowed: to specify if comment is allowed inside start term.
Tokens: to specify grammar terms which comment is not allowed.
Is Case Free: to specify whether target language is case sensitive.
Free Spaces: to specify space characters in target language.
Production is of the following form: NonterminalTerm::=Term. where:
Term may be BiTerm, PrimitiveTerm or UiniTerm.
BiTerm may be ChoiceTerm, ConcatenationTerm or DifferenceTerm.
PrimitiveTerm may be NonterminalTerm or TerminalTerm.
NonterminalTerm is a grammatical variable.
TerminalTerm may be DelimitedTerm, RangeTerm, or StringTerm and they are defined in detailed description.
UniTerm may be EnclosedTerm, OptionalTerm or RepeatedTerm and they are defined in detailed description.
Reorder or rename above doesn't change the formalism as long as the unification of lexical and grammatical syntax in the claim is preserved, wherein lexical tokens are specified as special grammar nonterminals.

4. The nonterminal term in claim 3, wherein the nonterminal term is further defined with a substructure to distinguish different instances or occurrences of the same term in a production:
<termName@instanceName>
The change of brackets, or deliminator, or order of contents doesn't affect the semantics of the formalism.

5. The generic parser of claim 1, wherein it further consists of.
A BNF reader, which reads text form BNF definition of a grammar and parses it into BNF objects in computer memory;
A generic parser, which uses the in-memory BNF objects to parse and unparse an of a BNF term.
The generic parser keeps comments. The generic parser can parser any language when it is defined in the extended BNF forms above. The bi-directional instance tree produced by the parser, wherein it is constructed from the BNF definition of a language and an instance of the language.

6. The BNF API in claim 1, wherein it consists of the following methods:
BNF reading API, which reads a language grammar in BNF text and creates in-memory objects for BNF terms;
Parser API, which is used to parse an instance of the language;
Instance API, which is used to access parsed instance and its components;
Skeleton generator API, which generates a program code based on BNF structure of a language, where the program can be a program in any language.

7. The program transformation specification language in claim 1, wherein it consists of the following:
Extends BNF to express two languages by using different nonterminal term quotes, such as <<term>> in a target language term corresponds to <term> in a source language. The change of quotes doesn't change this formalism.
Using UserDefined as user defined instance term name prefix to express information, which is not available from a source language. Other marking method, such as suffix or special deliminator, can be used for this purpose.
The invocation of transformation function and condition and their definition.

8. The program transformation specification language in claim 1, wherein it can be used to check the validity of target program and its components on the fly. The program transformation specification language can be used as the control of a generic program transformation system. The program transformation specification language can also be used to describe a specific program transformation system as in the present patent description.

9. The statement-to-statement program transformation approach for COBOL to Java transformation, wherein it consists of:
Statement-to-statement approach for data statement transformation;
Statement-to-statement approach for operational statement transformation.

10. The Statement-to-statement approach for data statement transformation in claim 9, which consists of:
Generates one Java field declaration and field initialization statement for simple COBOL type using predefined class in a library;
For array, it is translated into corresponding array, with index changed accordingly;
Generates one Java field declaration and field initialization statement for a COBOL group type, along with group field type class as inner class;
Generates one field declaration and field initialization statement for redefine field with constructor having two parameters for defined field and offset, along with group field type class as inner class;
Generates a class definition for a COBOL group type.
This approach in present claim can be applied into other languages besides COBOL, such as C language if C structure is used instead of COBOL group. The change of implementation details doesn't change this claim as long as statement-to-statement relationship exists by inheritance, encapsulation, and polymorphism.

11. Statement-to-statement approach for COBOL statement transformation in claim 9, wherein it consists of:
Translation of accessor of source identifier in target program,
Generate one sentence directly from an original sentence if such a match exists,
Generate one sentence indirectly from an original sentence if a one to many mapping exists. Here “indirectly” means using a predefined method call in a class in a predefined library.
If no source to target mapping exists, an exception is thrown for an address-change statement, like goto statement and goback statement, and it is caught and processed in a method in a super class address feature of a subclass. Other address-related statement, like perform statement with through clause, is implemented in super class to use address feature of a subclass. Thus there is no code in subclass for address associated implementation and exception handling for transformation purpose.
The Statement-to-statement approach above can be applied into other languages besides Java and COBOL, such as FORTPAN and C# language. The change of implementation details doesn't change this claim as long as statement-to-statement relationship exists for maintainability while performance is kept.

12. The skeleton generator API in claim 6, wherein it generates classes based on BNF nonterminal terms. This approach generates program skeleton for further manual customization.

13. The goto statement elimination approach in claim 1, where it uses exception handling existing in target language without adding extra mechanism for goto statement related control flow translation.

14. The same goto statement approach by use of exception handling in claim 13 can be applied in any source computer language which has goto statement or similar address related statement, which languages includes, but not limited to, COBOL, C, C++, Fortran and assembly language as a source language. The approach also applies to any target computer language with exception handling mechanism as target languages, which includes languages, but not limited to, Ada, C++, Java, C#.

15. The embedded statement processing approach in claim 1, wherein it consists of:
Preprocess embedded statement into a comment and a special marker statement,
At the translation time of the special marker statement, retrieve the comment back and perform embedded statement processing to escape host language syntax checking.

16. The embedded statement processing approach in claim 15 simplifies the BNF definition of source language and thus makes transformation system less complex. It can be applied to, but not limited to, embedded SQL, embedded CICS statement processing in COBOL. It can also applied to other embedded statement processing in a language besides COBOL.

17. The COBOL to Java program transformation system in claim 2, wherein it consists of:
A COBOL program source code as input;
A Java program source code as output;
A precompiler or preprocessor, which performs the following:
Copy and paste COBOL copy book and embedded SQL INCLUDE file,
Replace of COBOL comment into BNF supported comment in form:
/* comment */
Merge continuous lines,
Delete debugging lines,
Process special free-format remark such as AUTHOR paragraph,
Delete COBOL sequence number and out of right margin text;
A generic parser as in claim 6, where it is implemented in Java package BNF;
A translator, which is implemented in Java package cobol2java and it calls corresponding translation procedure class in Java package cobol.lib to perform translation process;
A BNF definition of COBOL 74/85 grammar as text file as defined in claim 3;
A set of translation procedure as a set of Java classes generated by skeleton generator in claim 12 and manually customized. There is a one to one corresponding between a non-token BNF term and a Java class. The naming convention is deleting word deliminators and changing first letter to capital.
A translation configuration file, which specifies information, which is not available from the input program, such as JDBC connection parameters.
A Java Library for COBOL, which implements:
Simple types of COBOL in Java by means of COBOL terms,
Java implementation of COBOL group behavior as Group classes,
Common behavior of all COBOL data types as Base class,
COBOL file types: Sequential, relative and indexed,
Intrinsic functions,
GotoException and EndOfProgram exception for goto statement and goback statement processing,
Shorthand complex COBOL statements, which requires multiple lines of Java implementation, as Java methods in cobol.lang.Cobol.
Goto statement and perform statement processing in abstract class cobol.lang.CoProgram for translated class to inherit.

18. The translated Java program in claim 17 has only one new methods added, entry point method for application and subroutine.

19. The translated Java program in claim 17 has statement-to-statement corresponding to original COBOL program. Therefore the program control flow, or business logic, is kept intact. The translated Java program in claim 17 has the same functionality as the original COBOL program in terms of input/output behavior, that is, given the same input they produce the same output in the same semantics. The translated Java program in claim 17 has the same time complexity as the original COBOL program in terms of the order of the number of machine instructions with respect to an input. The translated Java program in claim 17 is grammatical correct according to Sun Microsystems's Java standard. Therefore the translated Java source generated can be compiled and run automatically and pragmatically. The COBOL program in claim 17 requires no manual edition.

20. The behavior of COBOL to Java program transformation system in claim 17 can be customized to special requirements by:
Adding/deleting/changing BNF definition of the source language, and/or
Change translation configuration file contents, and/or
Adding/deleting/changing translation procedure classes, and/or
Changing implementation method of translator, and/or
Change method implementation of library without changing method signature.
